(19) United States
(12) Patent Application Publication
(10) Pub. No.: US 2022/0257453 A1
(43) Pub. Date: Aug. 18, 2022

(54) MASSAGE MODULE AND MASSAGE APPARATUS COMPRISING SAME

(71) Applicant: BODYFRIEND CO., LTD., SEOUL (KR)

(72) Inventors: Gi Won UM, Seoul (KR); Ji Hyoung LIM, Seoul (KR); Sung Chan CHOI, Seoul (KR); Deok Hyun KONG, Seoul (KR)

(21) Appl. No.: 17/634,083

(22) PCT Filed: Aug. 13, 2020
(86) PCT No.: PCT/KR2020/010796

§ 371 Date: Feb. 9, 2022

(30) Foreign Application Priority Data
Aug. 19, 2019 (KR) 10-2019-0101379

(51) Int. Cl. A61H 15/00

(52) U.S. Cl. CPC A61H 15/0078; A61H 2201/501; A61H 2201/5048; A61H 2201/1215; A61H 2015/0007; A61H 2201/0149; A61H 2201/5058

(57) ABSTRACT

A massage module according to an embodiment includes: a support plate including a circular opening therein; a massage body provided in the circular opening of the support plate; and a rotating mechanism for rotating the massage body relative to the support plate, wherein the massage body includes: a massage unit which provides a massage to a user through mechanical stimulation; a rotating plate provided to be rotatably moved relative to the support plate by the rotating mechanism; and a moving mechanism provided in the rotating plate to move the massage unit in a direction perpendicular to the rotation plane of the rotating plate. The rotating plate includes a through-opening through which the moving mechanism can pass, and the moving mechanism can pass through the through-opening to move the massage unit between a first position and a second position.

### TECHNICAL FIELD

The present invention relates to a massage module and a massage apparatus including the same, and more particularly, to a massage module including a rotating mechanism and a moving mechanism which are capable of performing a swing motion and a three-dimensional (3D) motion at the same time and a massage apparatus including the same.

### BACKGROUND ART

A massage is a complementary medical therapy of adjusting a physical modulation of a person to be massaged, aiding the circulation of blood, and relieving fatigue of the person to be massaged by applying a variety of forms of mechanical stimulation to a part of a body of the person to be massaged such as kneading, pushing, pulling, drumming, or moving the part of the body of the person to be massaged.

Rising massage demand has caused an increase in the demand for a massage apparatus or a massage tool which provides an artificial massage function due to financial reasons or time constraints. That is, according to an increase in the demand for relaxing tense muscles while releasing fatigue or stress through a massage, a variety of massage apparatuses which are efficient in time and cost have been released.

Recently, people's interest in health has increased, massage apparatuses have changed to electronic devices which provide a variety of additional functions and/or medical functions in addition to simply providing a massage function and thus research on a method of efficiently controlling a massage apparatus has continued.

Particularly, since users have different body shapes, the demand of users for a massage apparatus in which a massage module which provides a massage can reach an optimum position according to a user's body shape has increased.

### DISCLOSURE

### Technical Problem

The present invention is directed to providing a massage module and a massage apparatus capable of performing a swing motion and a three-dimensional (3D) motion to adjust a position according to a body shape of a user.

Aspects of the embodiments are not limited to the above aspects, and other unstated aspects can be clearly understood by those of ordinary skill in the art from the specification and the attached drawings.

### Technical Solution

One aspect of the present invention provides a massage module including a support plate including a circular opening therein, a massage body disposed in the circular opening of the support plate, and a rotating mechanism configured to rotate the massage body relative to the support plate. Here, the massage body includes a massage unit configured to provide a massage to a user through mechanical stimulation, a rotating plate disposed to be rotatably moved relative to the support plate by the rotating mechanism, and a moving mechanism disposed on the rotating plate and configured to move the massage unit in a direction perpendicular to a rotation plane of the rotating plate. Also, the rotating plate includes a through opening through which the moving mechanism is able to pass, and the moving mechanism passes through the through opening and moves the massage unit between a first position and a second position.

The rotating mechanism may include a first motor and a first power transmission device configured to transmit power supplied from the first motor to the rotating plate. Also, the rotating plate may include a tooth-shaped portion formed on at least a part of an outer circumferential surface and engaged with the first power transmission device to rotate.

The massage module may further include a rotation detector configured to detect a rotation angle of the massage body relative to the support plate.

The rotation detector may include a member to be detected which is disposed on the rotating plate and a plurality of detection sensors arranged at certain intervals on a periphery of the circular opening of the support plate. Here, the plurality of detection sensors may sense a position of the member to be detected to detect the rotation angle of the massage body relative to the support plate.

The support plate may include an accommodation groove configured to accommodate the rotating plate, and the rotating plate may be accommodated in the accommodation groove and disposed in the same plane with the support plate.

The moving mechanism may include a second motor and a second power transmission device configured to transmit power supplied from the second motor to the massage unit. Here, the massage unit may be connected to the moving mechanism and moved between the first position and the second position.

The rotating plate may further include a reinforcing member formed to surround a periphery of the through opening, and the moving mechanism may be disposed on the reinforcing member.

The massage module may further include a cover configured to cover at least parts of the rotating plate and the support plate when the rotating plate is disposed in the accommodation groove of the support plate. Here, the rotating plate may further include a plurality of protruding portions formed on surfaces which come into contact with the support plate and the cover.

A plurality of such protruding portions formed on an upper surface of the rotating plate and a plurality of such protruding portions formed on a lower surface may be alternately arranged.

Another aspect of the present invention provides a massage apparatus including a massage module, a main frame configured to provide a path on which the massage module is movable, and a control portion. Here, the massage module includes a support plate including a circular opening therein, a massage body disposed in the circular opening of the support plate, and a rotating mechanism configured to rotate the massage body relative to the support plate. The massage body includes a massage unit configured to provide a massage to a user through mechanical stimulation, a rotating plate disposed to be rotatably moved relative to the support plate by the rotating mechanism, and a moving mechanism disposed on the rotating plate and configured to move the massage unit in a direction perpendicular to a rotation plane of the rotating plate. Also, the rotating plate includes a through opening through which the moving mechanism is able to pass, and the moving mechanism passes through the through opening and moves the massage unit between a first position and a second position.

The main frame may include a rack gear disposed along a movement path. Here, the massage module may further include a lifting/lowering device including an actuator and a lifting/lowering gear configured to receive power from the actuator. Also, the lifting/lowering gear may be engaged with the rack gear so that the massage module may be moved along the movement path of the main frame.

The control portion may be able to control rotation of the massage body and movement of the massage unit.

The massage unit may include a plurality of arms and a plurality of rollers disposed on distal ends of the respective arms, and the control portion may control movement of the respective arms.

### Advantageous Effects

According to embodiments, since a massage module includes both a rotating mechanism and a moving mechanism, a swing motion and a three-dimensional (3D) motion may be performed at the same time. Also, since a massage apparatus includes a lifting/lowering device capable of moving the massage module along a main frame, a position of the massage module may be three-dimensionally adjusted according to a body shape of a user. Accordingly, the massage module and the massage apparatus according to the embodiments may provide an optimum massage to the user.

Effects of the embodiments are not limited to the above effects, and other unstated effects can be clearly understood by those of ordinary skill in the art from the specification and the attached drawings.

### DESCRIPTION OF DRAWINGS

A variety of aspects will now be described with reference to the drawings. Here, like reference numerals are used to refer to generally like elements. In the following embodiments, for the purpose of description, a plurality of particular details will be provided to allow one or more aspects to be fully understood. However, it will be apparent that the aspect(s) can be implemented without such particular details. In other examples, well-known structures and apparatuses will be shown in block diagrams to facilitate description of one or more aspects.

FIG. 1 is a view illustrating a massage apparatus according to one embodiment of the present disclosure.

FIG. 2 is a view illustrating a main frame according to one embodiment of the present disclosure.

FIG. 3 is a view illustrating elements of the massage apparatus according to one embodiment of the present disclosure.

FIG. 4 is a view illustrating a massage module according to one embodiment of the present disclosure.

FIG. 5 is an exploded perspective view of the massage module shown in FIG. 4.

FIG. 6A is a top view of a support plate according to one embodiment of the present disclosure.

FIG. 6B is a bottom view of the support plate according to one embodiment of the present disclosure.

FIG. 7 is a perspective view of a massage body according to one embodiment of the present disclosure.

FIGS. 8A to 8C are views illustrating a swing motion of the massage module according to one embodiment of the present disclosure.

FIG. 9 is a view illustrating an operation of detecting an angle of the swing motion of the massage module according to one embodiment of the present disclosure.

FIG. 10 is a view illustrating surfaces of a rotating plate of the massage body which come into contact with other members when the massage body, the support plate, and a cover according to one embodiment of the present disclosure are assembled.

FIG. 11 is a bottom view of the massage body according to one embodiment of the present disclosure.

FIGS. 12A and 12B are views illustrating a three-dimensional (3D) motion of the massage module according to one embodiment of the present disclosure.

### BEST MODE

A massage module includes a support plate including a circular opening therein, a massage body disposed in the circular opening of the support plate, and a rotating mechanism configured to rotate the massage body relative to the support plate. Here, the massage body includes a massage unit configured to provide a massage to a user through mechanical stimulation, a rotating plate disposed to be rotatably moved relative to the support plate by the rotating mechanism, and a moving mechanism disposed on the rotating plate and configured to move the massage unit in a direction perpendicular to a rotation plane of the rotating plate. Also, the rotating plate includes a through opening through which the moving mechanism is able to pass, and the moving mechanism passes through the through opening and moves the massage unit between a first position and a second position.

### MODE FOR INVENTION

The purposes, features, and advantages of the present disclosure will be more apparent from the following embodiment related to the attached drawings. The following particular structures and functional descriptions are exemplified for describing embodiments according to the concept of the present disclosure. The embodiments according to the concept of the present invention can be implemented in a variety of forms, and the present disclosure should not be construed as being limited to the embodiments described in the specification or application.

Since the embodiments according to the concept of the present disclosure may be variously changed and may have a variety of forms, particular embodiments will be illustrated in the drawings and described in detail in the specification or application. However, it should be understood that the embodiments according to the concept of the present disclosure are not limited to the particular embodiments and include all changes, equivalents, and substitutes which are included in the concept and technical scope of the present disclosure.

Although the terms first, second, and/or the like may be used for describing a variety of components, the components are not limited by the terms. The terms are used only for distinguishing one component from other components. For example, without departing from the scope according to the concept of the present disclosure, a first component may be referred to as a second component, and similarly, a second component may be referred to as a first component.

When one component is said to be “connected” or “joined” to another component, it should be understood that the one component may be directly connected or joined to the other component or another component may be present therebetween. On the other hand, when one component is said to be “directly connected” or “directly joined” to another component, it should be understood that no other component is present therebetween. Other expressions describing relationships between components, e.g., “between” and “directly between.” “adjacent” and “directly adjacent,” and the like should be similarly construed.

The terms used herein are used merely to describe particular embodiments and are not intended to limit the present disclosure. The singular forms include the plural forms as well unless the context clearly indicates otherwise. It should be understood that the terms “comprise,” “have,” and the like intend to designate the presence of stated features, numerals, stages, operations, elements, components, or combinations thereof and do not exclude the presence or addition of one or more other features, numerals, stages, operations, elements, components, or combinations thereof.

All the terms used herein, including technical or scientific terms, unless defined otherwise, have the same meanings generally understood by those of ordinary skill in the art. Generally used terms such as terms defined in dictionaries should be understood as having meanings which coincide with contextual meanings of the related art and will not be understood with ideally or excessively formal meanings unless clearly defined herein.

In the specification, an actuator is a component capable of providing a driving force. For example, an actuator may be a motor, a linear motor, an electronic motor, a direct current (DC) motor, an alternating current (AC) motor, a linear actuator, an electric actuator, or the like but is not limited thereto.

In the specification, a spiral rod is a linear member having a spiral groove and may be implemented using a metal material. For example, the spiral rod may include a cylindrical bar having a spiral groove on a surface thereof. Also, the spiral rod may include a metal lead screw.

In the specification, a binaural beat may be audio information having a particular form capable of adjusting brainwaves.

In the specification, according to one embodiment, a massage apparatus may be a massage apparatus including a body massage portion and a leg massage portion. Also, according to another embodiment, a body massage portion 100 and a leg massage portion 300 may exist as separate detached apparatuses (for example, a body massage apparatus and a leg massage apparatus) and a massage apparatus may be the body massage apparatus or the leg massage apparatus.

Hereinafter, embodiments of the present disclosure will be described in detail with reference to the attached drawings.

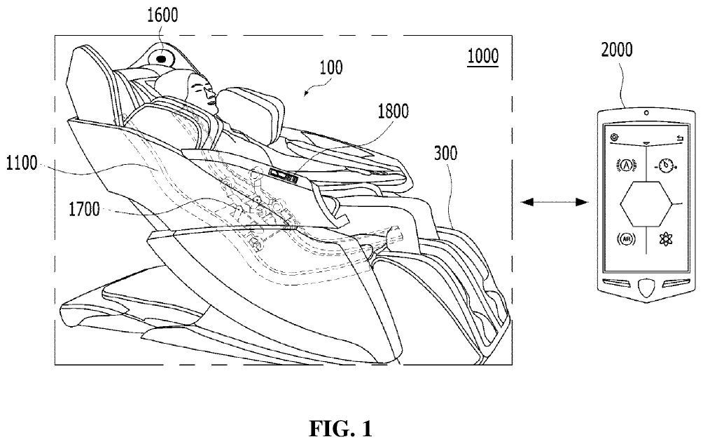

FIG. 1 is a view illustrating a massage apparatus according to one embodiment of the present disclosure.

A massage apparatus 1000 according to one embodiment of the present disclosure may form an area for accommodating at least one part of a body of a user and may include a body massage portion 100 configured to massage the body of the user and a leg massage portion 300 configured to massage the legs of the user.

The body massage portion 100 may provide massage to at least a part of the body of the user. The body massage portion 100 may include a massage module 1700 configured to provide a massage function to at least one part of the user's body, an audio output module 1600 configured to provide an audio output having an arbitrary form to the user, a main frame 1100 configured to form a framework of the body massage portion 100, and a user input/output portion 1800 configured to receive an input having an arbitrary form from the user.

The components included in the body massage portion 100 are merely an exemplary embodiment, and the body massage portion 100 may include a variety of components in addition to the above components.

Also, a shape and a structure of the massage apparatus 1000 shown in FIG. 1 are merely examples, and the massage apparatus 1000 having a variety of forms may be included in the scope of the present disclosure without departing from the scope defined in the claims of the present disclosure.

The body massage portion 100 may form a space having an arbitrary shape for accommodating the user. The body massage portion 100 may include a space having a shape corresponding to a shape of the user's body. For example, as shown in FIG. 1, the body massage portion 100 may be implemented as a seat type capable of accommodating the entirety or a part of the user's body.

A part of the body massage portion 100 which comes into contact with the ground may include an arbitrary material for increasing a frictional force or an arbitrary member (for example, a non-slip pad and the like) configured to increase a frictional force and may include wheels for reinforcing movability of the massage apparatus 1000.

The body massage portion 100 may at least partially slide. For example, when the body massage portion 100 starts a massage, at least a part of the body massage portion 100 may slide forward. Also, the body massage portion 100 may tilt rearward. As a result, the body massage portion 100 may provide a massage while tilted rearward.

According to one embodiment of the present disclosure, the massage apparatus 1000 may include one or more air cells (not shown). The air cells may be located on a shoulder region and a pelvic region of the user, an arm massage portion, a leg massage portion 300, and the like but are not limited thereto and may be arranged on a variety of parts of the massage apparatus 1000.

The massage apparatus 1000 may include an air supply portion, and the air supply portion may inflate the air cells by supplying air to the air cells. The air supply portion may be located inside the body massage portion 100 and may be located in the leg massage portion 300. Also, the air supply portion may be located outside the massage apparatus 1000.

The leg massage portion 300 may provide a leg massage to the user. For example, the leg massage portion 300 may include a calf massage portion configured to massage the calves of the user and/or a foot massage portion configured to massage the feet of the user.

The leg massage portion 300 may have a length which is adjustable according to body characteristics of the user. For example, when a tall user uses the massage apparatus 1000, since a length of his or her calves is long, it is necessary to increase a length of the leg massage portion 300. Also, when a short user uses the massage apparatus 1000, since a length of his or her calves is short, it is necessary to decrease a length of the leg massage portion 300. Accordingly, the leg massage portion 300 may provide a massage customized to the height of the user.

The massage module 1700 may be provided inside the body massage portion 100 to provide mechanical stimulation having an arbitrary form to the user accommodated in the body massage portion 100. As shown in FIG. 1, the massage module 1700 may move along the main frame 1100 provided inside the body massage portion 100.

For example, the main frame 1100 of the body massage portion 100 may include a rack gear and the massage module 1700 may provide mechanical stimulation to a variety of regions of the user's body while moving along the rack gear. The massage module 1700 may include a ball massage unit or a roller massage unit but is not limited thereto.

The main frame 1100 is configured to form a framework of an internal configuration of the body massage portion 100 and may be implemented using a metal material, plastic material, or the like. For example, the main frame 1100 may be implemented using iron, an alloy, steel, or the like but is not limited thereto and may be implemented using a variety of rigid materials.

According to one embodiment of the present disclosure, the massage apparatus 1000 may include the audio output module 1600. The audio output module 1600 may be provided at a variety of positions. For example, the audio output module 1600 may include a plurality of output units such as an upper end audio output unit disposed on an upper end of a seat portion which comes into contact with the user, a front audio output unit attached to a front end of each of left and right arm massage portions of the seat portion, and/or a rear audio output unit attached to a rear end of the arm massage portion, and the like but is not limited thereto. In this case, the audio output module 1600 may provide a stereophonic sound like 5.1 surround sound but is not limited thereto.

According to one embodiment of the present disclosure, the user may control the massage apparatus 1000 using a massage apparatus control device 2000. The massage apparatus control device 2000 may be connected to the massage apparatus 1000 through wired communication and/or wireless communication.

The massage apparatus control device 2000 may include a remote controller, a cellular phone, a personal digital assistant, and the like but is not limited thereto and may include a variety of electronic devices which are connectable to the massage apparatus 1000 through wired or wireless communication.

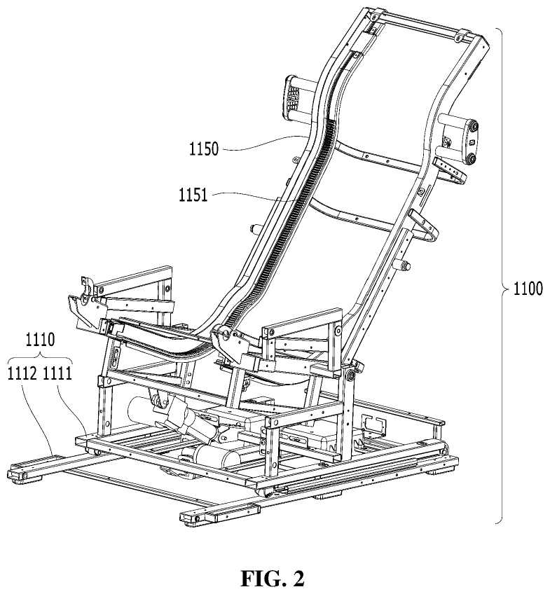

FIG. 2 is a view illustrating the main frame according to one embodiment of the present disclosure.

According to one embodiment of the present disclosure, the main frame 1000 may include an upper frame 1150 in which the massage module 1700 is provided and a base frame 1110 configured to support the upper frame 1150.

A rack gear 1151 may be provided on at least a part of the upper frame 1150. The rack gear 1151 is a member configured to guide vertical movement of the body massage module 1700 and may include a plurality of furrow portions and a plurality of ridge portions.

According to one embodiment of the present invention, such rack gears 1151 may be provided on both sides of the upper frame 1150 to face each other and the body massage module 1700 may move along the rack gears 1151.

For example, the body massage module 1700 may include a gear 1722 engaged with the rack gear 1151. Here, the gear 1722 rotates due to an actuator provided on the body massage module 1700 and thus the body massage module 1700 may move upward or downward.

The rack gear 1151 may be implemented using a metal material or a plastic material. For example, the rack gear 1151 may be implemented using iron, steel, an alloy, reinforced plastic, a melamine resin, a phenol resin, and the like but is not limited thereto.

The upper frame 1150 may be implemented in a variety of shapes. For example, the upper frame 1150 may be classified, according to shapes, as an S-frame, an L-frame, an S&L-frame, or a double S&L-frame, but is not limited thereto.

The S-frame is a frame including a shape in which at least a part of the upper frame 1150 is curved like an S. The L-frame is a frame including a shape in which at least a pan of the upper frame 1150 is curved like an L. The S&L-frame is a frame including both a shape curved like an S and a shape curved like an L. The double S&L-frame is a frame including a shape curved like an L and a shape having two parts curved like an S.

The base frame 1110 is a part of the main frame 1100 which supports the upper frame 1150 and comes into contact with the ground. The base frame 1110 may include an upper base frame 1111 and a lower base frame 1112.

The upper base frame 1111 may support the upper frame 1150, and the lower base frame 1112 may come into contact with the ground. Also, the upper base frame 1111 may be located to come into contact with the lower base frame 1112.

According to one embodiment of the present invention, the upper base frame 1111 may move along the lower base frame 1112. For example, the upper base frame 1111 may slide forward or backward along the lower base frame 1112. In this case, the upper frame 1150 may be connected to the upper base frame 1111 and may move according to movement of the upper base frame 1111.

For example, when the upper base frame 1111 moves forward, the upper frame 1150 may also move forward. When the upper base frame 1111 moves rearward, the upper frame 1150 may also move rearward. Accordingly, the body massage portion 100 may be allowed to slide.

In detail, to allow the upper base frame 1111 to move, a moving wheel may be provided on a bottom of the upper base frame 1111. Also, a guide member configured to guide the moving wheel may be provided on a top of the lower base frame 1112. As the moving wheel provided on the upper base frame 1111 moves along the guide member provided on the lower base frame 1112, forward movement or rearward movement of the upper base frame 1111 may be allowed.

According to another embodiment of the present disclosure, the massage apparatus 1000 may not provide a sliding function. In this case, the base frame 1110 may not be separated into the upper and lower frames.

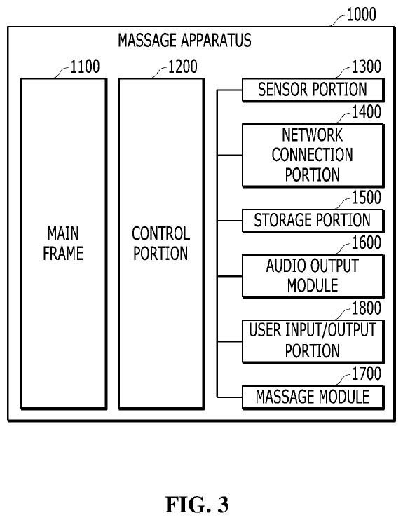

FIG. 3 is a view illustrating elements of the massage apparatus according to one embodiment of the present disclosure. According to one embodiment of the present disclosure, the massage apparatus 1000 may include one or more of the main frame 1100, a control portion 1200, a sensor portion 1300, the user input/output portion 1800, the audio output module 1600, a network connection portion 1400, and the massage module 1700.

The control portion 1200 may control movement of the massage apparatus 1000. The control portion 1200 may be implemented using one processor or may be implemented using a plurality of processors. When the control portion 1200 is implemented using a plurality of processors, at least some of the plurality of processors may be at positions that are physically spaced apart. Also, the control portion 1200 is not limited thereto and may be implemented using a variety of methods.

According to one embodiment of the present disclosure, the control portion 1200 may control an operation of the massage apparatus 1000. For example, the massage apparatus 1000 may include a plurality of actuators, and the massage apparatus 1000 may control the operation of the massage apparatus 1000 by controlling operations of the plurality of actuators. For example, the massage apparatus 1000 may include one or more of an actuator for moving the massage module 1700, at least one actuator included in the massage module 1700, a back angle actuator, a leg angle actuator, a foot massage actuator, a leg length adjusting actuator, and a sliding actuator and the control portion 1200 may control the actuators to control the operation of the massage apparatus 1000.

The actuator for moving the massage module 1700 is an actuator configured to allow the massage module 1700 to be vertically movable, and the massage module 1700 may move along the rack gear due to an operation of the actuator for moving the massage module 1700.

The back angle actuator is an actuator configured to adjust an angle of a part of the massage apparatus 1000 which comes into contact with the back of the user, and an angle of the back of the massage apparatus 1000 may be adjusted by an operation of the back angle actuator.

The leg angle actuator is an actuator configured to adjust an angle of the leg massage portion 300 of the massage apparatus 1000, and an angle between the leg massage portion 300 and the body massage portion 100 may be adjusted by an operation of the leg angle actuator.

The foot massage actuator is an actuator configured to operate the foot massage module 1700 included in the leg massage portion 300. The massage apparatus 1000 may provide a foot massage to the user by utilizing the foot massage actuator.

The massage module 1700 may include one or more actuators, and the control portion 1200 may provide a variety of massage operations by operating the one or more actuators. For example, the control portion 1200 may provide a drum massage, a kneading massage, and the like by operating the one or more actuators included in the massage module 1700 but is not limited thereto and may provide a variety of massage motions.

The leg length adjusting actuator is an actuator configured to adjust a length of the leg massage portion 300. For example, the control portion 1200 may adjust the length of the leg massage portion 300 according to the user by utilizing the leg length adjusting actuator, and thus the user may receive a massage suitable for his or her body shape.

The sliding actuator facilitates a sliding operation of the massage apparatus 1000. For example, a horizontal upper base frame 1114a may be movable forward or rearward through an operation of the sliding actuator, and therefore the upper frame connected to the horizontal upper base frame 1114a may move forward or rearward.

The sensor portion 1300 may obtain a variety of information using one or more sensors. For example, the sensors may include a pressure sensor, an infrared sensor, a light-emitting diode (LED) sensor, and the like but are not limited thereto.

Also, the sensor portion 1300 may include a biometric information acquisition sensor. The biometric information acquisition sensor may acquire fingerprint information, face information, voice information, iris information, weight information, electrocardiogram information, body composition information, and the like but the information is not limited thereto and may include a variety of types of biometric information.

According to another embodiment of the present disclosure, the massage apparatus 1000 may sense a contact area and/or a contact position with the user through sensors. Also, the massage apparatus 1000 may acquire shoulder position information of the user using the sensor portion 1300. Also, the massage apparatus 1000 may provide a customized massage based on acquired information. For example, when the massage apparatus 1000 provides a shoulder massage, the massage apparatus 1000 may recognize a shoulder position of the user on the basis of the information acquired using the sensor portion 1300 and may provide the shoulder massage to the user according to a recognition result.

As another embodiment, when the user takes a seat on the massage apparatus 1000, the massage apparatus 1000 may sense a shape of a back region of the user through sensors. Accordingly, the massage apparatus 1000 may provide a customized massage based on acquired shape information of the back region. For example, as will be described below, a massage unit 1741 of the massage apparatus 1000 may rotate and move in a direction perpendicular to a rotation direction. Accordingly, the control portion 1200 of the massage apparatus 1000 may control the rotation direction of the rotation of the massage unit 1741 and the movement in the direction perpendicular thereto at the same time to provide an optimum massage customized to the shape of the back region of the user.

Also, as will be described below, since respective arms 1742 of the massage unit 1741 may be moved by different moving mechanisms, the respective arms 1742 may be moved independently. Accordingly, the control portion 1200 of the massage apparatus 1000 may control movement of each arm 1742 of the massage unit 1741 to provide an optimum massage even when body regions which receive massages are asymmetrical to each other.

The massage apparatus 1000 according to one embodiment of the present disclosure may include the network connection portion 1400. The network connection portion 1400 may perform communication with the module in the massage apparatus 1000, an external massage apparatus 1000, and a user terminal 2000 through a network having an arbitrary form. The network connection portion 1400 may include a wired/wireless access module configured to access the network. As wireless access technologies, for example, wireless local area network (WLAN), Wi-Fi, wireless broadband (WiBro). Worldwide Interoperability for Microwave Access (WiMAX), High Speed Downlink Packet Access (HSDPA), and the like may be used. As wired access technologies, for example, digital subscriber line (xDSL), fiber-to-the-home (FTTH), power line communication (PLC), and the like may be used. Also, the network connection portion may include a short range communication module to transmit and receive data with an arbitrary device/terminal located in a short range. For example, as short range communication technologies. Bluetooth, radio frequency identification (RFID), Infrared Data Association (IrDA), ultra wideband (UWB), ZigBec, and the like may be used but the present invention is not limited thereto.

A storage portion 1500 may store a variety of information related to the massage apparatus 1000. For example, the storage portion 1500 may include massage control information and personal authentication information but is not limited thereto.

The storage portion 1500 may be implemented using a non-volatile storage medium capable of continuously storing arbitrary data. For example, the storage portion 1500 may not only include a disk, an optical disc, and a magneto-optical storage device but may also include a storage device based on a flash memory and/or battery-backup memory but is not limited thereto.

Also, the storage portion 1500 may include a memory. The memory may be a volatile storage device that is a main storage device which a processor directly accesses such as a random access memory (RAM), examples of which include a dynamic RAM (DRAM), a static RAM (SRAM), and the like, and in which stored information is instantaneously deleted when power is off, but is not limited thereto. The memory may be operated by the control portion 1200.

The audio output module 1600 may provide an audio output having an arbitrary form to the user. For example, the audio output module 1600 may output a sound source and/or binaural beat optimized for a massage pattern provided by the massage apparatus 1000 to user to provide brain stimulation to the user. The audio output module 1600 may output an acoustic signal received through a network (not shown) or stored in an internal/external storage medium (not shown). For example, the audio output module 1600 may output the sound source through network connection (for example, Bluetooth connection or the like) with the user terminal 2000 under the control of the user terminal 2000. Also, the audio output module 1600 may output an acoustic signal having an arbitrary form which is generated in relation to the operation of the massage apparatus 1000.

The user input/output portion 1800 may perform an input function of receiving an instruction from the user in relation to controlling of the operation of the massage apparatus 1000 and an output function of outputting information in relation to the operation of the massage apparatus to the user. The user input/output portion 1800 may include an input/output portion and a control device which are built in the massage apparatus.

The user input/output portion 1800 may be implemented in a variety of forms. For example, the user input/output portion 1800 may be included in the body massage portion 100 and may be included in the leg massage portion 30) but is not limited thereto.

The massage apparatus 1000 may acquire a variety of instructions from the user through the user input/output portion 1800. For example, the massage apparatus 1000 may receive arbitrary instructions with respect to an option of a massage module, an option of a massage type, an option of a massage intensity, an option of a massage time, an option of a massage region, an option with respect to a position and motion of the body massage portion 100, an option with respect to turning on/off of the power of the massage apparatus 1000, an option with respect to whether to perform a thermal function, an option in relation to reproducing of a sound source, and the like but is not limited thereto.

According to another embodiment of the present disclosure, the user input/output portion 1800 may include, according to a preset user setting function, autonomously preset function, or the like, hot key type buttons and/or option buttons configured to execute a choice of a direction, cancellation, input, and the like.

The user input/output portion 1800 may be implemented using a keypad, a dome switch, a touch pad (pressure sensing/capacitive sensing), a jog wheel, a jog switch, and the like but is not limited thereto. Also, the user input/output portion 1800 may acquire an instruction from an utterance of the user on the basis of a voice recognition technology.

The user input/output portion 1800 may include a display configured to display an operational state of the massage apparatus 1000, a current state of the user, and the like. In this case, the display may include at least one of a liquid crystal display (LCD), a thin-film-transistor LCD (TFT LCD), an organic LED (OLED), a flexible display, and a three-dimensional (3D) display but is not limited thereto.

The massage apparatus 1000 according to one embodiment of the present disclosure may include the main frame 1100 and the massage module 1700. As described above with reference to FIGS. 1 and 2, the main frame 1100 may provide a path on which the massage module 1700 is movable, and the massage module 1700 is a component configured to provide mechanical stimulation to the user and may move along the main frame 1100.

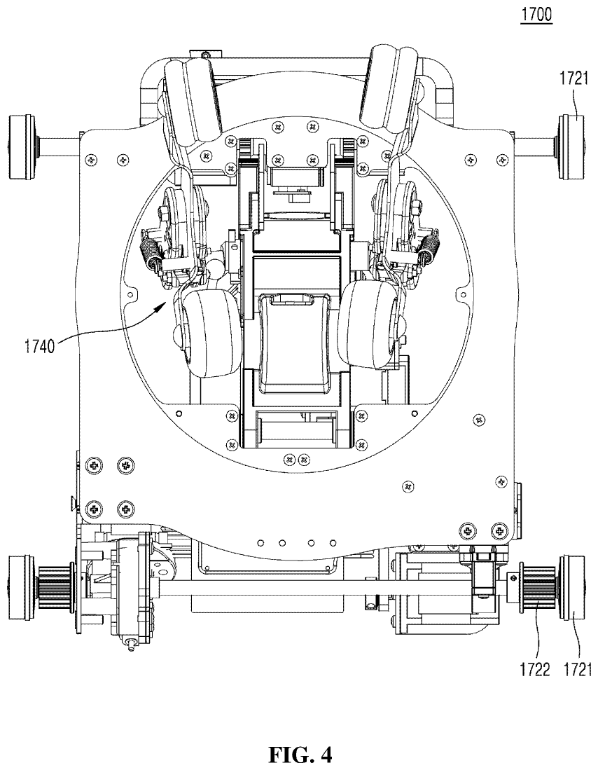

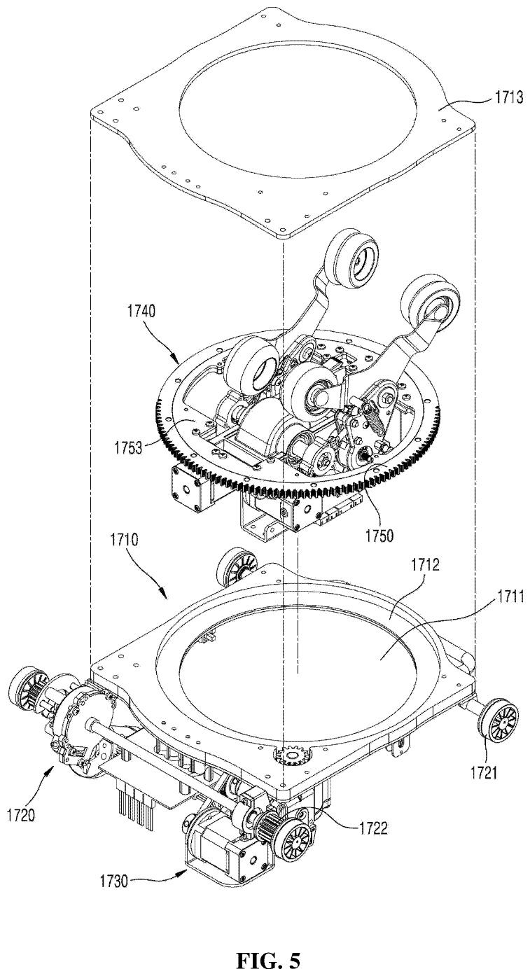

FIG. 4 is a view illustrating the massage module according to one embodiment of the present disclosure, and FIG. 5 is an exploded perspective view of the massage module shown in FIG. 4. For convenience of description, an upper side and a lower side will be described on the basis of a state shown in FIG. 5.

Referring to FIGS. 4 and 5, the massage module 1700 includes a support plate 1710, a massage body 1740 disposed on the support plate 1710, and a cover 1713 configured to prevent the massage body 1740 from being separated from the support plate 1710 by covering at least parts of the support plate 1710 and the massage body 1740.

The support plate 1710 may include a lifting/lowering device 1720 including an actuator and a power transmission device and a lifting/lowering gear 1722 engaged with the rack gear 1151 of the main frame 1100 and configured to receive power from the lifting/lowering device 1720. Here, the lifting/lowering gear 1722 rotates due to the actuator of the lifting/lowering device 1720, and thus the massage module 1700 may move upward or downward. Here, the main frame 1100 may include rails (not shown) configured to guide movement of the massage module 1700, and the massage module 1700 may include guide rollers 1721 configured to move along the rails. Accordingly, the massage module 17X) may stably move upward or downward along the main frame 1100.

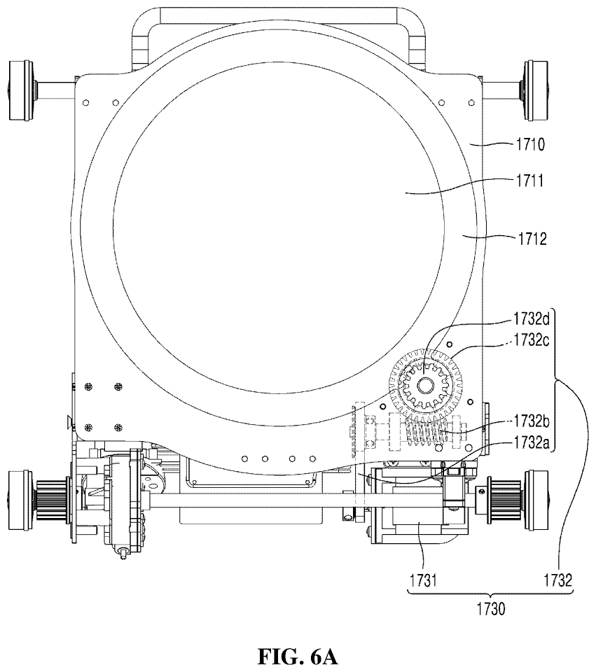

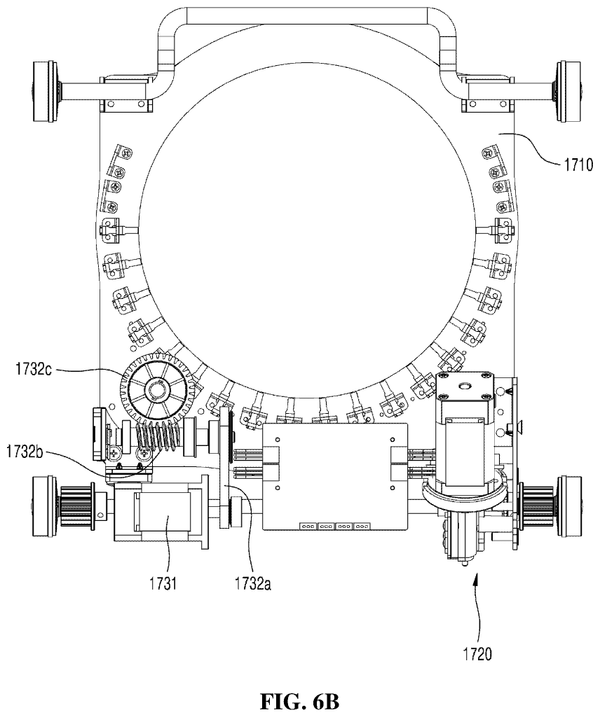

FIG. 6A is a top view of the support plate according to one embodiment of the present disclosure, and FIG. 6B is a bottom view of the support plate according to one embodiment of the present disclosure.

Referring to FIGS. 6A and 6B, the support plate 1710 includes a circular opening 1711 therein, and an accommodation groove 1712 in which the massage body 1740 may be accommodated is formed on an outer circumferential surface of the circular opening 1711. As shown in FIG. 5, since the accommodation groove 1712 is formed to have a shape corresponding to a rotating plate 1750 of the massage body 1740, the rotating plate 1750 may be accommodated in the accommodation groove 1712. For example, since the accommodation groove 1712 is formed to have a height equal to a thickness of the rotating plate 1750, when the rotating plate 1750 is accommodated in the accommodation groove 1712, the rotating plate 1750 and the support plate 1710 may be disposed in the same plane.

Also, the support plate 1710 may include a rotating mechanism 1730 capable of rotating the rotating plate 1750 of the massage body 1740.

The rotating mechanism 1730 may include a first motor 1731 and a first power transmission device 1732 configured to transmit power supplied from the first motor 1731 to the rotating plate 1750. For example, the first power transmission device 1732 of the rotating mechanism 1730 may include a belt 1732a connected to the first motor 1731, a worm gear 1732b fixedly coupled to a rotating shaft which rotates due to the belt 1732a, a helical gear 1732c engaged with the worm gear 1732b, and a pinion gear 1732d fixedly coupled to the same shaft as the helical gear 1732c. However, it will be understood by those of ordinary skill in the art that the first power transmission device 1732 of the rotating mechanism 1730 is not limited to the above embodiment and may include a variety of modified examples in types and numbers of power transmission devices capable of transmitting power of the rotating mechanism 1730.

The pinion gear 1732d of the rotating mechanism 1730 is engaged with a tooth-shaped portion 1751 of the rotating plate 1750 which will be described below, and therefore a driving force of the first motor 1731 may be transmitted by the first power transmission device 1732 so that the rotating plate 1750 may be rotated.

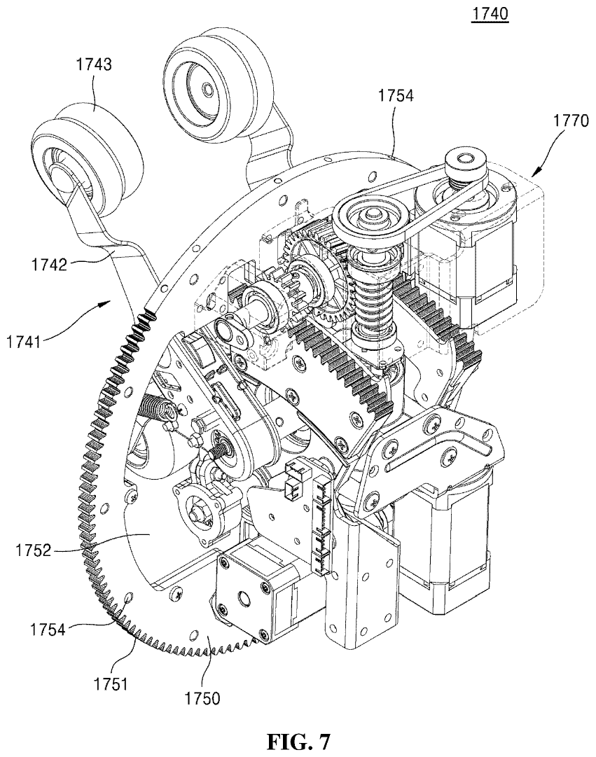

FIG. 7 is a perspective view of the massage body according to one embodiment of the present disclosure.

Referring to FIG. 7, the massage body 1740 may include the massage unit 1741 configured to provide a massage to the user using mechanical stimulation, the rotating plate 1750 disposed on the support plate 1710 to be rotatable relative thereto, and a moving mechanism 1770 disposed on the rotating plate 1750 and capable of moving the massage unit 1741 in a direction perpendicular to a rotation plane of the rotating plate 1750.

The massage unit 1741 may include an arm 1742 and a plurality of rollers 1743 disposed on distal ends of the arm 1742 and configured to come into contact with the user's body. Here, like the embodiment shown in FIG. 7, two such arms 1742 are disposed to be spaced apart from each other, the arms 1742 may have shapes diverging into opposite strands, and the rollers 1743 may be disposed on the distal end of each of the arms 1742. However, the shapes and numbers of the arms 1742 and the plurality of rollers 1743 are not limited by the above description. For example, each of the arms 1742 may be a single arm which does not diverge, and the massage unit may include, instead of the plurality of rollers 1743, ball-shaped members disposed on the distal ends of the arms.

The tooth-shaped portion 1751 including a plurality of furrow portions and a plurality of ridge portions is formed on at least a part of an outer circumferential surface of the rotating plate 1750, and a through opening 1752 is formed in the rotating plate 1750. Here, the massage unit 1741 and the moving mechanism 1770 of the massage body 1740 are installed on the rotating plate 1750 to pass through the through opening 1752 of the rotating plate 1750.

For example, the rotating plate 1750 may be manufactured using a plastic material. In this case, there may be a problem that the rotating plate 1750 in which the through opening 1752 is formed may be inadequate for supporting the massage unit 1741 and the moving mechanism 1770 by itself. Accordingly, as shown in FIG. 5, the rotating plate 1750 may further include a reinforcing member 1753 installed on a peripheral part of the through opening 1752. The reinforcing member 1753 may include a material having high rigidity to support the massage unit 1741 and the moving mechanism 1770. For example, the reinforcing member 1753 may be a metal material but is not limited thereto. Also, the moving mechanism 1770 of the massage body 1740 is coupled to the reinforcing member 1753 so that the rotating plate 1750 may simultaneously support weights of the massage unit 1741 and the moving mechanism 1770 and withstand vibration which may occur in the moving mechanism 1770.

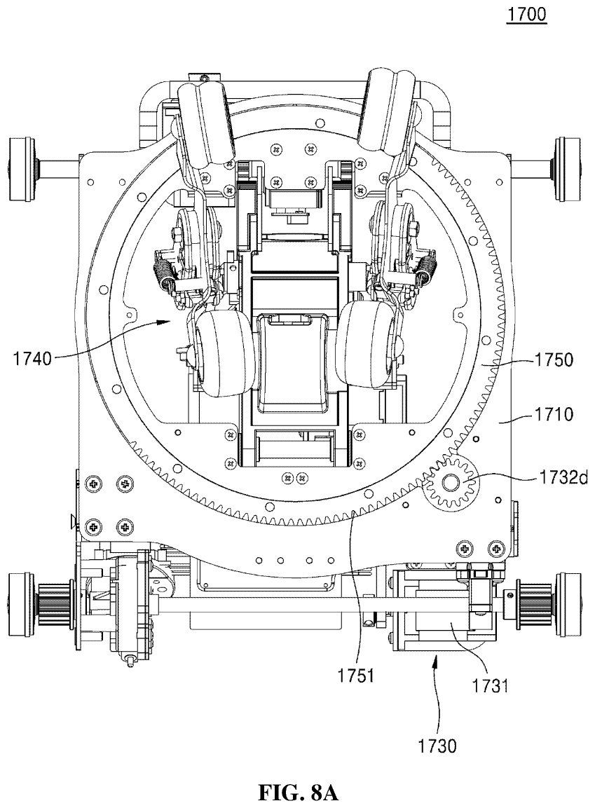

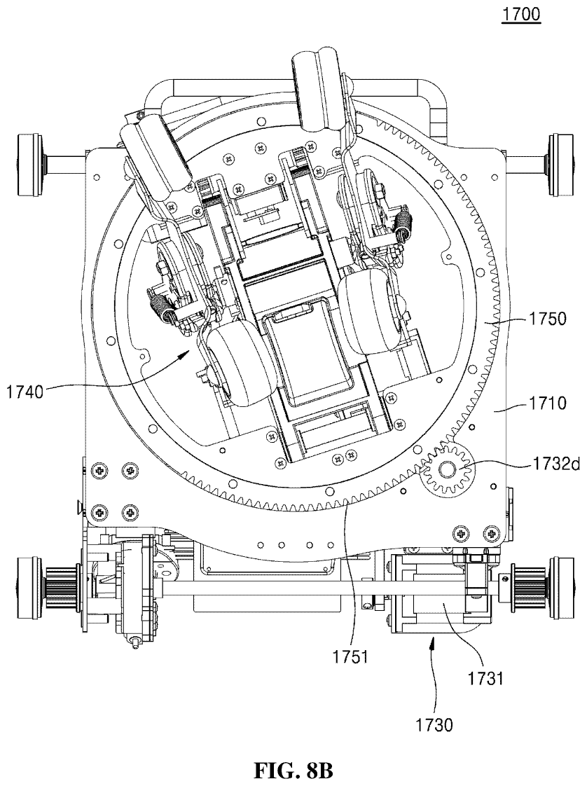

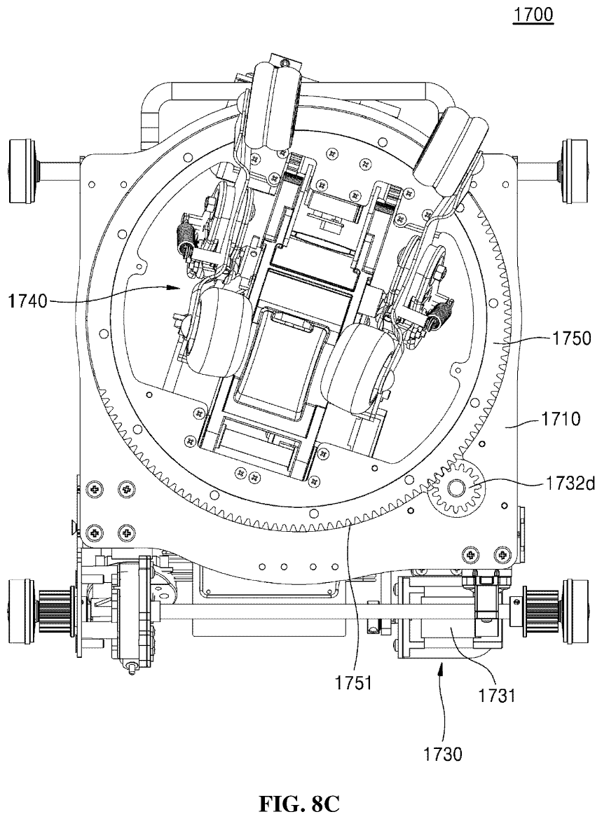

FIGS. 8A to 8C are views illustrating a swing motion of the massage module according to one embodiment of the present disclosure.

The swing motion is rotation of the massage body 1704 of the massage module 1700 relative to the support plate 1710. As shown in FIGS. 8A to 8C, the tooth-shaped portion 1751 of the rotating plate 1750 is engaged with the pinion gear 1732d of the rotating mechanism 1730 disposed on the support plate 1710 so that the rotating plate 1750 may be rotated by driving of the first motor 1731. FIG. 8A illustrates a state before the massage body 1740 rotates relative to the support plate 1710, and FIGS. 8B and 8C illustrate states in which the massage body 1740 has rotated relative to the support plate 1710 in directions opposite to each other.

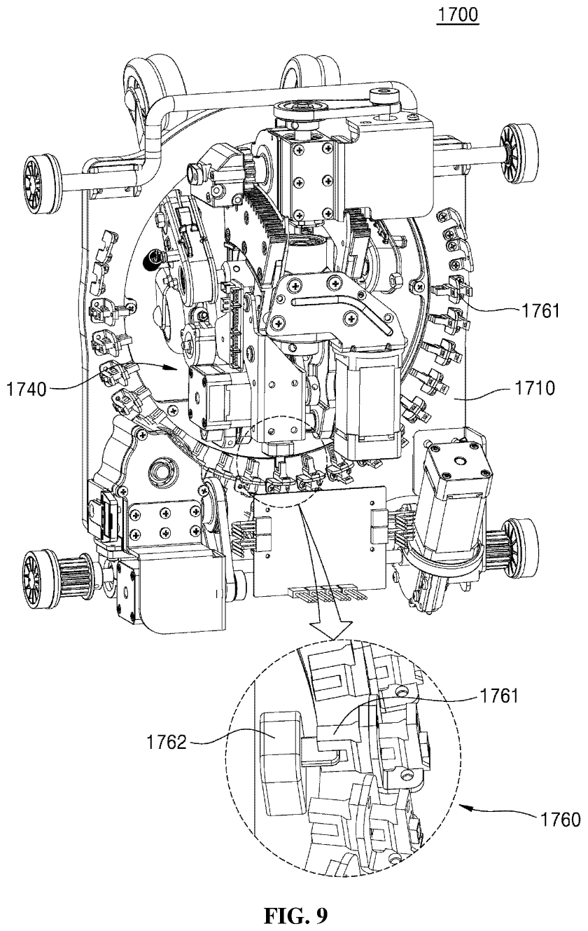

FIG. 9 is a view illustrating an operation of detecting an angle of the swing motion of the massage module according to one embodiment of the present disclosure.

Referring to FIG. 9, the massage module 1700 may further include a rotation detector 1760 configured to detect a rotation angle of the massage body 1740 relative to the support plate 1710. The rotation detector 1760 may include a member to be detected which is disposed on the rotating plate 1750 and a plurality of detection sensors arranged at certain intervals on a periphery of the circular opening 1711 of the support plate 1710. The plurality of detection sensors may sense a position of the member to be detected to detect the rotation angle of the massage body 1740 relative to the support plate 1710.

For example, in an embodiment shown in FIG. 9, the rotation detector 1760 may include photo interrupter sensors 1761 arranged at certain intervals on the periphery of the circular opening 1711 of the support plate 1710 and an obstruction member 1762 disposed on the rotating plate 1750 of the massage body 1740. Each of the photo interrupter sensors 1761 includes a light emitting element and a light receiving element, and the obstruction member 1762 obstructs light emitted from the light emitting element of the photo interrupter sensor 1761. Accordingly, the rotation angle of the massage body 1740 may be measured by detecting the photo interrupter sensor 1761 in a state in which light received by the light receiving element is obstructed among the photo interrupter sensors 1761.

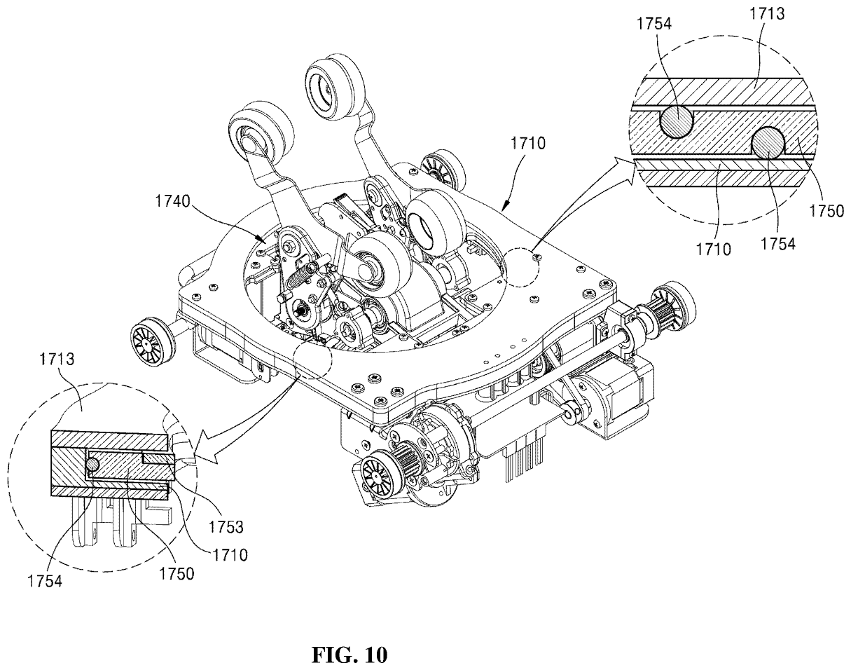

FIG. 10 is a view illustrating surfaces of the rotating plate of the massage body which come into contact with other members when the massage body, the support plate, and the cover according to one embodiment of the present disclosure are assembled.

Referring to FIG. 10, the rotating plate 1750 is accommodated in the support plate 1710 and the cover 1713 is installed thereabove. A plurality of protruding portions 1754 may be formed on the surfaces of the rotating plate 1750 which come into contact with the support plate 1710 and the cover 1713. When the rotating plate 1750 comes into surface contact with the support plate 1710 and the cover 1713, excessive frictional forces may occur between the respective members. Accordingly, in order to reduce the frictional force occurring between the rotating plate 1750 and other members, the plurality of protruding portions 1754 are formed on the surfaces of the rotating plate 1750 which come into contact with the support plate 1710 and the cover 1713. Here, as shown in FIG. 7, in one embodiment, the plurality of protruding portions 1754 may have a ball shape. However, any shape capable of forming point contact between the respective members may be included in other embodiments, and the present invention is not limited to the above embodiment.

Also, referring to the embodiment shown in FIG. 7, the plurality of protruding portions 1754 spaced apart at certain intervals may be formed on a side surface of the rotating plate 1750 on which the tooth-shaped portion 1751 is not formed, and the plurality of protruding portions 1754 spaced apart at certain intervals may be formed on both an upper surface and a lower surface of the rotating plate 1750. Also, referring to the embodiment shown in FIG. 10, the protruding portions 1754 on the upper surface of the rotating plate 1750 and the protruding portions 1754 on the lower surface may be alternately arranged. This may prevent forces applied to the upper surface and the lower surface of the rotating plate 1750 from being concentrated on a particular area and increase a life of the rotating plate 1750.

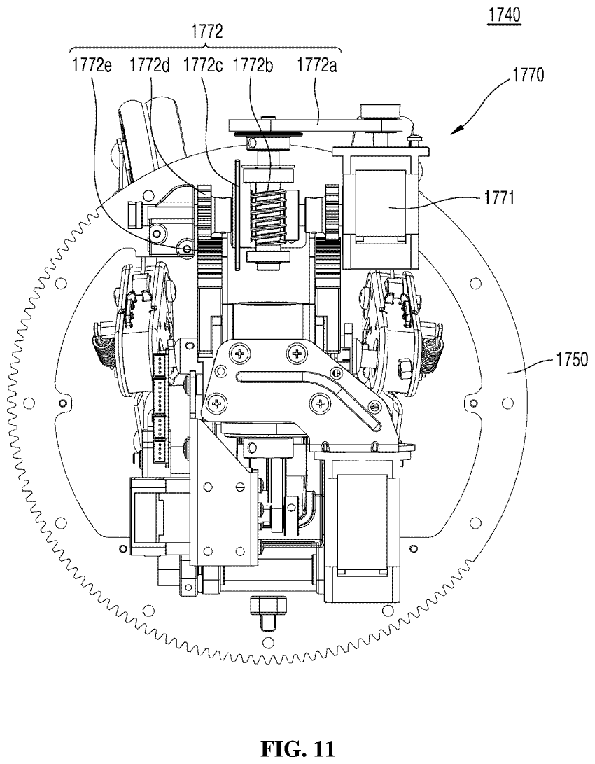

FIG. 11 is a bottom view of the massage body according to one embodiment of the present disclosure.

Referring to FIG. 11, the moving mechanism 1770 is installed on the rotating plate 1750. The moving mechanism 1770 may include a second motor 1771 and a second power transmission device 1772 configured to transmit power supplied from the second motor 1771 to the massage unit. For example, the second power transmission device 1772 of the moving mechanism 1770 may include a belt 1772a connected to the second motor 1771, a worm gear 1772b fixedly coupled to a rotating shaft which rotates due to the belt 1772a, a helical gear 1772c engaged with the worm gear 1772b, and a pinion gear 1772d fixedly coupled to the same shaft as the helical gear 1772c. However, it will be understood by those of ordinary skill in the art that the second power transmission device 1772 of the moving mechanism 1770 is not limited to the above embodiment and may include a variety of modified examples in types and numbers of power transmission devices capable of transmitting power of the moving mechanism 1770.

Since the moving mechanism 1770 may further include a rack gear 1772e connected to the massage unit and the pinion gear 1772d of the moving mechanism 1770 is engaged with the rack gear 1772e, a driving force of the second motor 1771 may be transmitted by the second power transmission device 1772 to move the massage unit 1741.

Meanwhile, although not shown in FIG. 11, the massage module 1700 may further include a second moving mechanism (not shown). Accordingly, any one of the arms 1742 of the massage unit 1741 may be moved by the moving mechanism 1770, and another arm 1742 of the massage unit 1741 may be moved by the second moving mechanism. Here, since the respective arms 1742 are moved by different moving mechanisms, the respective arms 1742 may be moved independently.

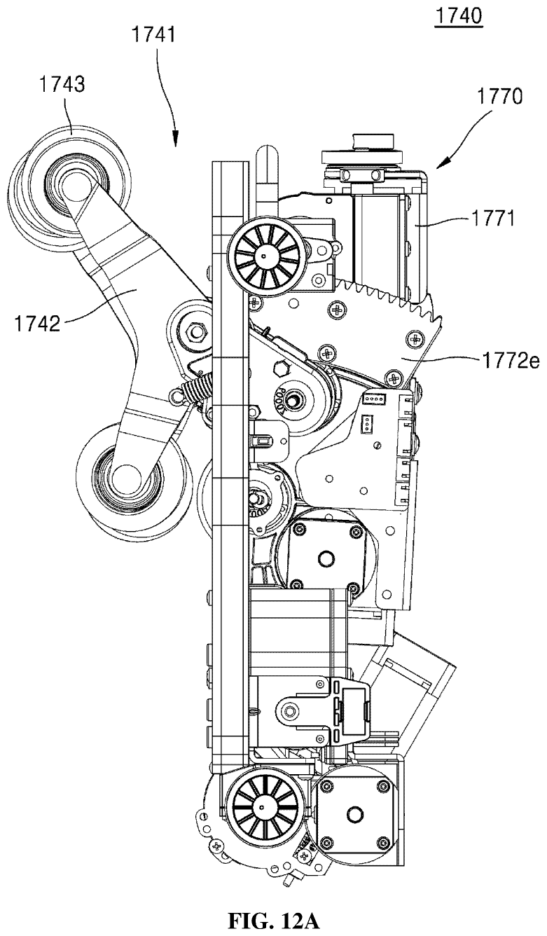

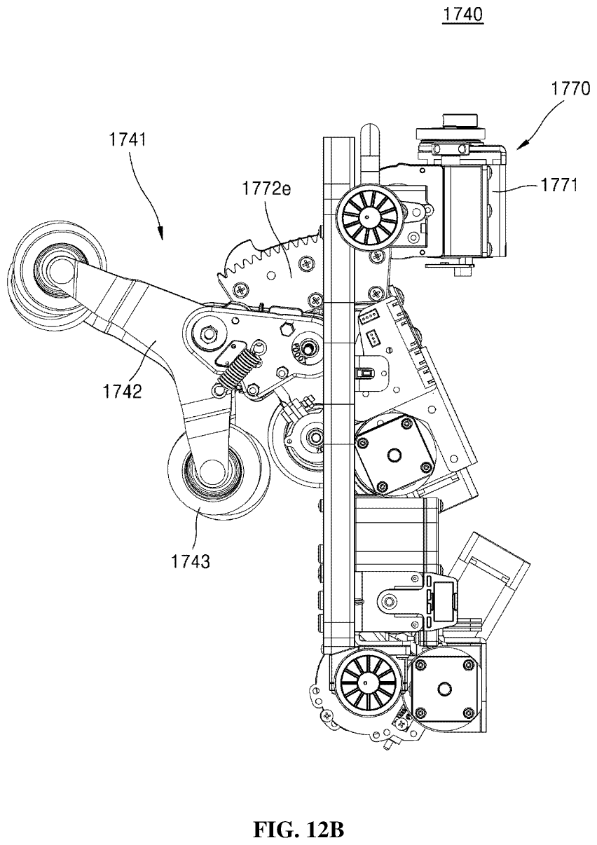

FIGS. 12A and 12B are views illustrating a 3D motion of the massage module according to one embodiment of the present disclosure.

The 3D motion is a motion of the massage body 1740 of the massage module 1700 in a direction perpendicular to the rotation plane of the rotating plate 1750. Accordingly, due to the 3D motion of the massage module, the massage apparatus may provide an optimum massage by allowing the massage unit to approach or retreat according to a body shape of the user.

As shown in FIGS. 12A and 12B, the massage unit 1741 of the massage body 1740 is connected to the rack gear 1772e. Since the driving force of the second motor 1771 of the moving mechanism 1770 is transmitted through the second power transmission device 1772, the rack gear 1772e of the second power transmission device 1772 may move between a first position far from the user and a second position closer to the user through the through opening 1752 of the rotating plate 1750. Accordingly, the massage unit 1741 connected to the rack gear 1772e may also move between the first position far from the user and the second position closer to the user through the 3D motion. FIG. 12A illustrates a state in which the massage unit 1741 is located at the first position, and FIG. 12B illustrates a state in which the massage unit 1741 has moved to the second position.

The description of the disclosed embodiments is provided to allow any one of ordinary skill in the art to utilize or execute the present invention. It will be apparent to those of ordinary skill in the art that a variety of modification of the embodiments may be made and the general principles defined herein are applicable to other embodiments without departing from the scope of the present invention. Therefore, the present invention is not limited to the embodiments disclosed herein and should be construed in the broadest range consistent with the principles described herein and novel features.

1. A massage module comprising:
a support plate comprising a circular opening therein;
a massage body disposed in the circular opening of the support plate; and
a rotating mechanism configured to rotate the massage body relative to the support plate,
wherein the massage body comprises:
a massage unit configured to provide a massage to a user through mechanical stimulation;
a rotating plate disposed to be rotatably moved relative to the support plate by the rotating mechanism; and
a moving mechanism disposed on the rotating plate and configured to move the massage unit in a direction perpendicular to a rotation plane of the rotating plate, and
wherein the rotating plate comprises a through opening through which the moving mechanism is able to pass, and the moving mechanism passes through the through opening and moves the massage unit between a rust position and a second position.

2. The massage module of claim 1, wherein the rotating mechanism comprises:
a first motor; and
a first power transmission device configured to transmit power supplied from the first motor to the rotating plate, and
wherein the rotating plate includes a tooth-shaped portion formed on at least a part of an outer circumferential surface and engaged with the first power transmission device to rotate.

3. The massage module of claim 2, further comprising a rotation detector configured to detect a rotation angle of the massage body relative to the support plate.

4. The massage module of claim 3, wherein the rotation detector comprises:
a member to be detected which is disposed on the rotating plate; and
a plurality of detection sensors arranged at certain intervals on a periphery of the circular opening of the support plate, and
wherein the plurality of detection sensors sense a position of the member to be detected to detect the rotation angle of the massage body relative to the support plate.

5. The massage module of claim 1, wherein the support plate comprises an accommodation groove configured to accommodate the rotating plate, and
wherein the rotating plate is accommodated in the accommodation groove and disposed in the same plane with the support plate.

6. The massage module of claim 1, wherein the moving mechanism comprises:
a second motor; and
a second power transmission device configured to transmit power supplied from the second motor to the massage unit, and
wherein the massage unit is connected to the moving mechanism and moved between the first position and the second position.

7. The massage module of claim 1, wherein the rotating plate further comprises a reinforcing member formed to surround a periphery of the through opening, and
wherein the moving mechanism is disposed on the reinforcing member.

8. The massage module of claim 5, further comprising a cover configured to cover at least parts of the rotating plate and the support plate when the rotating plate is disposed in the accommodation groove of the support plate,
wherein the rotating plate further comprises a plurality of protruding portions formed on surfaces which come into contact with the support plate and the cover.

9. The massage module of claim 8, wherein a plurality of such protruding portions formed on an upper surface of the rotating plate and a plurality of such protruding portions formed on a lower surface are alternately arranged.

10. A massage apparatus comprising:
a massage module;
a main frame configured to provide a path on which the massage module is movable; and
a control portion,
wherein the massage module comprises:
a support plate comprising a circular opening therein;
a massage body disposed in the circular opening of the support plate; and
a rotating mechanism configured to rotate the massage body relative to the support plate,
wherein the massage body comprises:
a massage unit configured to provide a massage to a user through mechanical stimulation;
a rotating plate disposed to be rotatably moved relative to the support plate by the rotating mechanism; and
a moving mechanism disposed on the rotating plate and configured to move the massage unit in a direction perpendicular to a rotation plane of the rotating plate, and
wherein the rotating plate comprises a through opening through which the moving mechanism is able to pass, and the moving mechanism passes through the through opening and moves the massage unit between a first position and a second position.

11. The massage apparatus of claim 10, wherein the main frame comprises a rack gear disposed along a movement path,
wherein the massage module further comprises a lifting/lowering device comprising an actuator and a lifting/lowering gear configured to receive power from the actuator, and
wherein the lifting/lowering gear is engaged with the rack gear so that the massage module is moved along the movement path of the main frame.

12. The massage apparatus of claim 10, wherein the control portion is able to control rotation of the massage body and movement of the massage unit.

13. The massage apparatus of claim 10, wherein the massage unit comprises a plurality of arms and a plurality of rollers disposed on distal ends of the respective arms,
wherein the massage body comprises a plurality of such moving mechanisms configured to move the plurality of arms in a direction perpendicular to the rotation plane of the rotating plate, and
wherein the control portion is capable of controlling movement of the respective arms.
